(19) United States
(12) Patent Application Publication
(10) Pub. No.: US 2024/0304831 A1
(43) Pub. Date: Sep. 12, 2024

(54) CATALYST FOR FUEL CELL, METHOD OF MANUFACTURING THE SAME, AND FUEL CELL INCLUDING THE SAME

(71) Applicant: KORENS RTX Co., Ltd., Gyeryong-si, Chungcheongnamdo (KR)

(72) Inventors: Dae Soo YANG, Daejeon (KR); Hyean Yeol PARK, Daejeon (KR); Tong Hyun KANG, Daejeon (KR)

(73) Assignee: KORENS RTX Co., Ltd., Gyeryong-si, Chungcheongnamdo (KR)

(21) Appl. No.: 18/451,924

(22) Filed: Aug. 18, 2023

(30) Foreign Application Priority Data
Dec. 28, 2022 (KR) 10-2022-0187459
Feb. 2, 2023 (KR) 10-2023-0014130

(51) Int. Cl. H01M 4/92; H01M 4/88

(52) U.S. Cl. CPC H01M 4/926; H01M 4/8825; H01M 4/8882

(57) ABSTRACT

Provided are a catalyst for a fuel cell, a method of manufacturing the same, and a fuel cell including the same. The method of preparing the catalyst for a fuel cell does not use a chemical reducing agent and therefore does not require a separate post-treatment process. In addition, through heat treatment, the structural stability of the catalyst and the active point of the oxygen reduction reaction are improved, and long-term stability can be achieved.

### CROSS-REFERENCE TO RELATED APPLICATION

This application claims the benefit of Korean Patent Applications No. 10-2022-0187459, filed on Dec. 28, 2022 and No. 10-2023-0014130, filed on Feb. 2, 2023 in the Korean Intellectual Property Office, the disclosure of which is incorporated herein in its entirety by reference.

### TECHNICAL FIELD

The present disclosure relates to a titanium-supported platinum catalyst, and more specifically, to a catalyst for a fuel cell, a method of producing the same, and a fuel cell using the same, in which the catalyst is a highly durable catalyst suitable for applications to fuel cells, platinum is first supported on a carbon support through in-situ irradiation of an electron beam, and then reduction of titanium metal on the platinum surface is induced so as to increase the electrochemical activity of the catalyst.

### BACKGROUND ART

Hydrogen, which is attracting attention as a next-generation eco-friendly energy source, is a power source that will lead the transition to a hydrogen economy society, and as one of these power sources, a polymer electrolyte membrane fuel cell (PEMFC) is an energy conversion device that can convert chemical energy into electrical energy that can be used for transportation and building power generation by using electricity generated in the process of combining hydrogen and oxygen, which are fuels.

The operating principle of fuel cells is that fuel (hydrogen, methanol, etc.) is fed to an anode, where the fuel is oxidized by a catalyst, while electrons are released and conducted through an external load to a cathode, where the oxidant is reduced by a catalyst again to produce water, generating electricity (non-patented reference, Yun Wang et al., Applied Energy 88 (2011) 981-1007).

Catalysts for a fuel cell mainly uses, as a carrier, carbon black with high electrical conductivity, large specific surface area, and large pore size. However, when used as a catalyst of an air electrode for a fuel cell, the performance and stability of platinum particles deteriorate due to delamination and agglomeration thereof, and when used as a catalyst of a fuel electrode, the carbon corrosion rate is high in long-term durability, causing delamination and agglomeration of metal catalyst particles and degradation of the overall membrane electrolyte assembly (MEA) performance.

In addition, alloying with 3d early transition metals can improve the activation of the catalyst surface by modulating the d-band vacancy, such as electronic effect or geometric effect, However, among the 3d early transition metal species Sc, V, Y, Zr, and Ti, Ti has extreme pro-oxidation properties, which may cause metal oxides to form on the platinum catalyst surface during the synthesis reaction.

TiO₂ has excellent oxidation resistance properties, but it also exhibits insulating properties, which can lead to initial degradation in the simple Pt/metal oxide form due to limited electron transfer pathways during oxygen reduction reactions.

Meanwhile, for high dispersion of the catalyst, interparticle agglomeration can be eliminated by using organic and inorganic surfactants, but post-treatment processes, such as acid treatment to remove surfactants or heat treatment in the presence of air, are essential to reveal the active point of the catalyst.

Therefore, a manufacturing method with an eco-friendly yet powerful reduction system is needed to control the pro-oxidation properties of 3d early transition metals.

### CONTENT OF DISCLOSURE

### Technical Problem

An objective of the present disclosure is to provide a method for preparing a catalyst for a fuel cell that can improve the structural stability and oxygen reduction reaction activity point of the catalyst and ensure long-term stability in order to solve the above problems.

### Technical Solution to Problem

An aspect of the present disclosure provides a method of producing a catalyst for a fuel cell includes forming a carbon support dispersion solution, forming a first metal precursor-mixed solution by mixing a solution of a first metal precursor with the carbon support dispersion solution, supporting a first metal by irradiating an electron beam on the first metal precursor-mixed solution, injecting a second metal precursor into a first metal-supported mixed solution, supporting a second metal by irradiating an electron beam on a second metal precursor-injected mixed solution, and heat-treating a second metal-supported carbon support.

In an embodiment, the carbon support may include at least one selected from reduced graphene oxide, graphene, graphite, single-walled carbon nanotubes, multi-walled carbon nanotubes, carbon nanohorns, carbon nanofibers, acetylene black, and furnace black.

In an embodiment, the first metal precursor may be a platinum (Pt) precursor.

In an embodiment, the first metal precursor may include at least one selected from platinum acetylacetonate, platinum acetate, platinum chloride, and platinum nitrate.

In an embodiment, in the forming of the first metal precursor-mixed solution, a pH of the first metal precursor-mixed solution may be adjusted to be basic.

In an embodiment, in the supporting of the first metal, the electron beam may be irradiated for 20 minutes or less.

In an embodiment, the second metal precursor includes at least one precursor of a transition metal selected from Ti, Sc, V, Y, Zr, Nb, La, Hf, and Ta.

In an embodiment, the second metal precursor may include at least one selected from TiCl₄, C₁₂H₂₈O₄Ti, Ti(OC₂H₅)₄, Ti(OBu)₄, C₁₂H₂₈O₄Ti, and [(CH₃)₂CHO]₂Ti(C₅H₇O₂)₂.

In an embodiment, the second metal precursor may be injected in-situ.

In an embodiment, in the injecting of the second metal precursor, a pH of the mixed solution may be adjusted to be basic.

In an embodiment, in the supporting of the second metal, the electron beam may be irradiated for 30 minutes or less.

In an embodiment, the supporting the second metal may include filtering and then drying the mixed solution to which the electron beam has been irradiated.

In an embodiment, the heat treatment temperature in the heat treatment process may be 800° C. to 950° C.

In an embodiment, the heat treatment time in the heat treatment process may be 1 hour to 5 hours.

Another aspect provides a catalyst for a fuel cell, prepared by using the method.

Another aspect provides a fuel cell including the catalyst for a fuel cell.

### Advantageous Effects of Disclosure

The method of manufacturing the catalyst for a fuel cell according to the present disclosure does not use a chemical reducing agent and therefore does not require a separate post-treatment process. In addition, through heat treatment, the structural stability of the catalyst and the active point of the oxygen reduction reaction are improved, and long-term stability can be achieved.

### BRIEF DESCRIPTION OF DRAWINGS

FIG. 1 is a flowchart sequentially illustrating a method of manufacturing a fuel cell catalyst according to an embodiment of the present disclosure.

FIG. 2 shows diagrams to explain a method of manufacturing a fuel cell catalyst according to an embodiment of the present disclosure.

FIGS. 3A to 3F show a transmission electron microscope (TEM) image of a fuel cell catalyst according to an embodiment of the present disclosure.

FIG. 4 shows an X-ray diffraction (XRD) result of a fuel cell catalyst according to an embodiment of the present disclosure.

FIGS. 5A to 5D show the results of evaluating the performance of the catalyst before heat treatment according to an embodiment of the present disclosure.

FIGS. 6A to 6D show the results of evaluating the performance of the catalyst after heat treatment according to an embodiment of the present disclosure.

FIGS. 7A and 7B show results of analyzing the performance of a fuel cell catalyst according to an embodiment of the present disclosure.

### SPECIFIC CONTENT FOR IMPLEMENTING THE DISCLOSURE

an embodiment of the present disclosure is shown in the accompanying drawings. However, this inventive concept may be embodied in many different forms, and should not be construed as being limited to the embodiments described herein. Rather, these embodiments are provided so that this disclosure will be thorough and complete, and will fully convey the scope of the inventive concept to those skilled in the art. Like reference numerals denote like components.

Terms used in this specification are for describing only specific embodiments and are not intended to limit the present inventive concept. The singular form used herein is intended to include the plural form including “at least one” unless the context clearly dictates otherwise. “At least one” should not be construed as limiting to the singular. The term “and/or” used herein includes a combination of one or more of the listed items. The terms “including” and/or “comprising” as used in the Detailed Description specify the presence of the stated features, areas, integers, processes, actions, components, and/or ingredients and do not preclude the presence or addition of one or more other features, areas, integers, processes, actions, components, ingredients, and/or groups thereof.

Unless defined otherwise, all terms (including technical and scientific terms) used herein have the same meaning as commonly understood by one of ordinary skill in the art to which this disclosure belongs. It will also be understood that terms, as defined in commonly used dictionaries, are to be construed to have a meaning consistent with their meaning in the context of the relevant art and this disclosure, and are not to be construed in an idealized or overly formal sense.

While particular embodiments have been described, currently unforeseen or unforeseen alternatives, modifications, variations, improvements and substantial equivalents may occur to applicants or those skilled in the art. Accordingly, the appended claims as filed and as may be amended are intended to embrace all such alternatives, modifications, variations, improvements and substantial equivalents.

In the following embodiments, terms such as first and second are not intended to be limiting, but are used to distinguish one component from another.

In the following embodiments, singular expressions include plural expressions unless the context clearly indicates otherwise.

When an embodiment is otherwise implementable, a specific process sequence may be performed differently from the described sequence. For example, two processes described in succession may be performed substantially simultaneously, or may be performed in an order reverse to the order described.

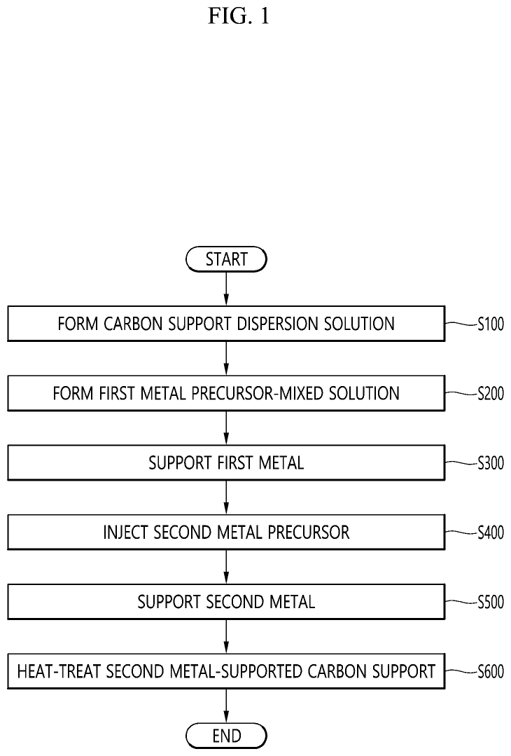

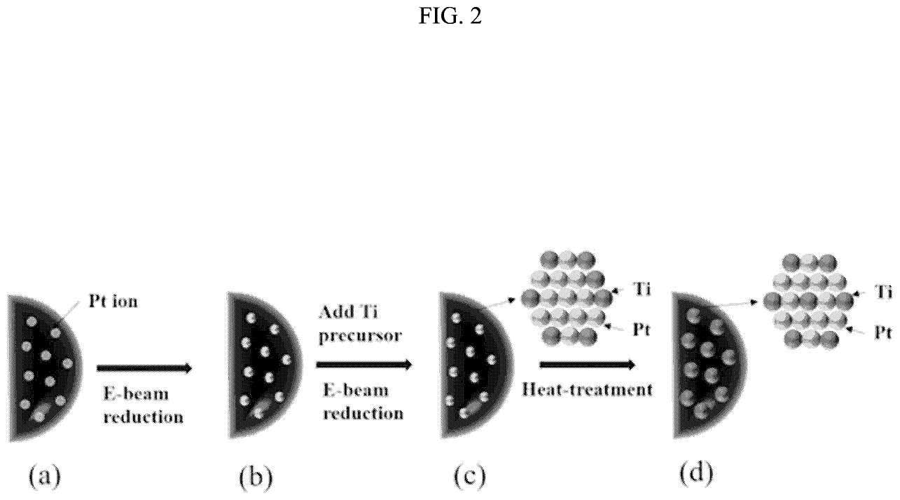

FIG. 1 is a flowchart sequentially illustrating a method of manufacturing a fuel cell catalyst according to an embodiment of the present disclosure, and (a) through (d) of FIG. 2 are diagrams to illustrate a method of preparing the catalyst for a fuel cell of FIG. 1.

Referring to FIG. 1 and (a) through (d) of FIG. 2, the present disclosure provides a method of producing a catalyst for a fuel cell, the method including forming a carbon support dispersion solution (S100), forming a first metal precursor-mixed solution (S200), supporting a first metal (S300), injecting a second metal precursor (S400), supporting a second metal (S500), and heat-treating a second metal-supported carbon support (S600).

In an embodiment of the present disclosure, forming the carbon support dispersion solution (S100) may be dispersing a carbon support in a solvent.

In an embodiment, the carbon support may include at least one selected from reduced graphene oxide, graphene, graphite, single-walled carbon nanotubes, multi-walled carbon nanotubes, carbon nanohorns, carbon nanofibers, acetylene black, and furnace black.

The solvent may be a mixed solvent including water and alcohol. The alcohol included in the solvent may be a polyhydric alcohol, and may include at least one selected from acetone, ethanol, isopropyl alcohol, ethanol, n-propyl alcohol, butanol, ethylene glycol, diethylene glycol, and glycerol.

A commonly used dispersion process may be used to prepare the carbon support dispersion solution, and for example, an ultrasonic dispersion process may be used. This dispersing process may be performed under the conditions of 3 seconds of operation-1 second of stop and the amplitude intensity of 50% or less.

In the forming a first metal precursor-mixed solution (S200), a solution of a first metal precursor is mixed with the carbon support dispersion solution to form the first metal precursor-mixed solution. (a) of FIG. 2 shows that a first metal precursor is mixed with a carbon support.

The first metal precursor may be a platinum (Pt) precursor. The Pt precursor may include at least one selected from platinum acetylacetonate, platinum acetate, platinum chloride, and platinum nitrate, and embodiments are not limited thereto.

The pH of the first metal precursor-mixed solution may be adjusted to be basic.

In this regard, any method can be used as long as the method can adjust the pH. The pH can be adjusted by metering injecting a pH adjusting agent. At least one of conventional pH adjusting agents such as NaOH, Na₂CO₃, KOH, K₂CO₃, or H₂SO₄ may be used, but embodiments are not limited thereto. For example, the pH range may be a pH of 7 to 14. In an embodiment, the pH may be adjusted to be 10 to 11 by using 1 M NaOH.

In the supporting the first metal (S300), an electron beam may be irradiated to the first metal precursor-mixed solution. (b) of FIG. 2 shows the carbon support supporting the first metal.

The electron beam may have energy of 0.1 MeV to 2 MeV, and an applied current may be 0.1 mA to 20 mA. When an electron beam is irradiated under the above conditions, ions of the first metal are reduced and the first metal is supported on the carbon support.

The electron beam irradiation time may be not more than 20 minutes; at least 10 seconds and not more than 20 minutes; at least 10 seconds and not more than 15 minutes; at least 10 seconds and not more than 10 minutes; at least 10 seconds and not more than 5 minutes; at least 10 seconds and not more than 2 minutes; or at least 10 seconds and not more than 1 minute. For example, the electron beam irradiation time may be not more than 1 minute.

In the irradiating the electron beam, the electron beam may be irradiated for an appropriate time according to the type of the first metal.

In the injecting the second metal precursor (S400), the second metal precursor is injected into the first metal precursor-mixed solution in which the first metal is supported.

The second metal precursor may include at least one precursor of transition metal selected from Ti, Sc, V, Y, Zr, Nb, La, Hf, and Ta. In an embodiment, the second metal precursor may include at least one selected from TiCl₄, C₁₂H₂₈O₄Ti, Ti(OC₂H₅)₄, Ti(OBu)₄, C₁₂H₂₈O₄Ti, and [(CH₃)₂CHO]₂Ti(C₅H₇O₂)₂, and embodiments are not limited thereto.

The injecting the second metal precursor may be injected by an in-situ method, but is not limited thereto. The injection rate may be 5 mL/min to 20 mL/min.

The injecting the second metal precursor may include adjusting the pH of the mixed solution to be basic. In this regard, any method can be used as long as the method can adjust the pH. The pH can be adjusted by metering injecting a pH adjusting agent. At least one of pH adjusting agents of the related art, such as H₂SO₄, HCl, HNO₃, Formic acid, NaOH, Na₂CO₃, KOH, K₂CO₃, may be used, and embodiments are not limited thereto. The pH range may be a pH of 7 to pH 14. In an embodiment, the pH may be adjusted to be 7 to 8 by using 1 M NaOH.

In the supporting the second metal (S50), an electron beam may be irradiated to the second metal precursor-mixed solution to alloy the second metal. (c) of FIG. 2 shows a second metal-supported carbon support.

The electron beam may have the energy of 0.1 MeV to 2 MeV, and an applied current may be 0.1 mA to 20 mA. When an electron beam is irradiated under the above conditions, ions of the second metal are reduced and the second metal is alloyed on the carbon support.

The electron beam irradiation time may be not more than 30 minutes; at least 1 minute and not more than 30 minutes; at least 1 minute and not more than 25 minutes; at least 1 minute and not more than 20 minutes; at least 10 minutes and not more than 30 minutes; at least 10 minutes and not more than 25 minutes; at least 10 minutes and not more than 20 minutes; at least 15 minutes and not more than 30 minutes; or at least 15 minutes and not more than 20. In an embodiment, the electron beam irradiation time may be not more than 20 minutes. The electron beam may be irradiated for an appropriate time according to the type of the second metal.

Chemical reduction methods of the related art, such as NaBH₄ and polyol using methods, require the addition of additional chemical reducing agents, and due to the oxidizing nature of the titanium precursor, it is more likely to exist as titanium dioxide than titanium.

Amorphous titanium metal has a strong affinity for oxygen. Accordingly, titanium metal may easily change into oxides or be overly reactive with oxygen atoms, leading to increased agglomeration of ionomers during electrode slurry preparation, and low electrical conductivity due to the formation of oxides, which can cause a decrease in the performance of the oxygen reduction reaction.

However, according to the present disclosure, by supporting a second metal by irradiating an electron beam as described above, the pro-oxidation properties of the second metal may be efficiently controlled and a highly dispersed supporting of the second metal may be induced. Also, by not using chemical reducing agents, there is no need for a separate post-treatment process to remove these agents.

Meanwhile, the supporting the second metal (S500) may include filtering and then drying the electron beam-irradiated precursor mixture solution. The method of filtration is not particularly limited. For example, a vacuum filter may be used for the filtering. The method of drying is not particularly limited. For example, drying may be performed in an oven. In an embodiment, when drying in an oven, drying may be performed at a temperature of not more than 100° C., for example, 60° C.

The heat treating the second metal-supported carbon support (S600) may be performed under a 20% hydrogen/argon mixed gas atmosphere, and embodiments are not limited thereto. (d) of FIG. 2 shows the heat-treated carbon support.

The heat treatment temperature may be 800° C. to 950° C.; 800° C. to 900° C.; 800° C. to 850° C.; 850° C. to 950° C., or 850° C. to 900° C. In an embodiment, the heat treatment temperature may be 850° C.

The heat treatment time may be 1 hour to 5 hours; 1 hour to 4 hours; 1 hour to 3 hours; 1 hour to 2 hours; 2 hours to 5 hours; 2 hours to 4 hours; or 2 hours to 3 hours. For example, the heat treatment time may be 2 hours.

Through the heat treatment process, the regular structure between titanium-platinum particles can be induced after heat treatment, so that the electrochemical activity and the electrophilic feature of titanium can be controlled. In addition, since a separate post-treatment process is not required after the heat treatment, the catalyst may be efficiently prepared.

Another aspect of the present disclosure provides a catalyst for a fuel cell manufactured by the manufacturing method and a fuel cell including the catalyst for a fuel cell.

The fuel cell may be a polymer electrolyte fuel cell, and a membrane electrode assembly of the polymer electrolyte fuel cell may include an anode, a cathode, and a polymer electrolyte membrane between them, and at least one of the anode and the cathode may include the catalyst of the present disclosure.

Hereinafter, the present disclosure will be described in detail through experimental examples.

However, the experimental examples to be described later are only to specifically illustrate the present disclosure in one aspect, and the present disclosure is not limited thereto.

### Experimental Example 1

### Transmission Electron Microscope (TEM) Analysis

TEM analysis was performed on the catalyst for a fuel cell synthesized by an electron beam according to the present disclosure. TEM analysis was performed by scanning at an accelerating voltage of 200 kV.

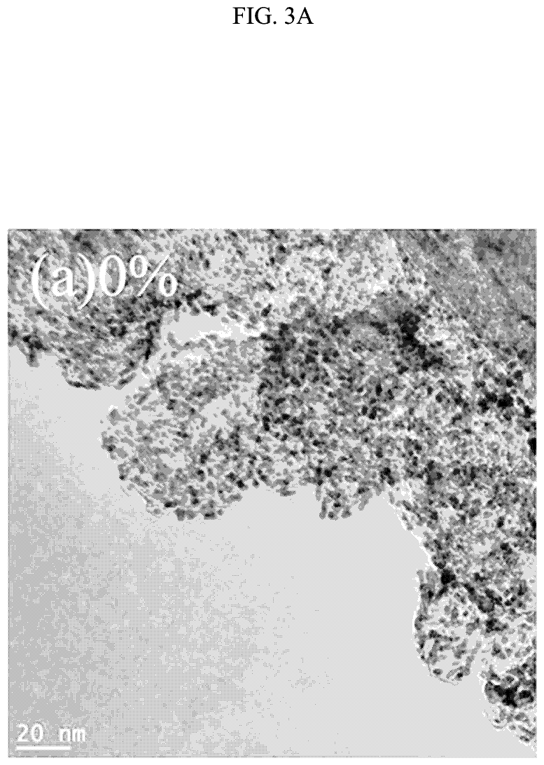

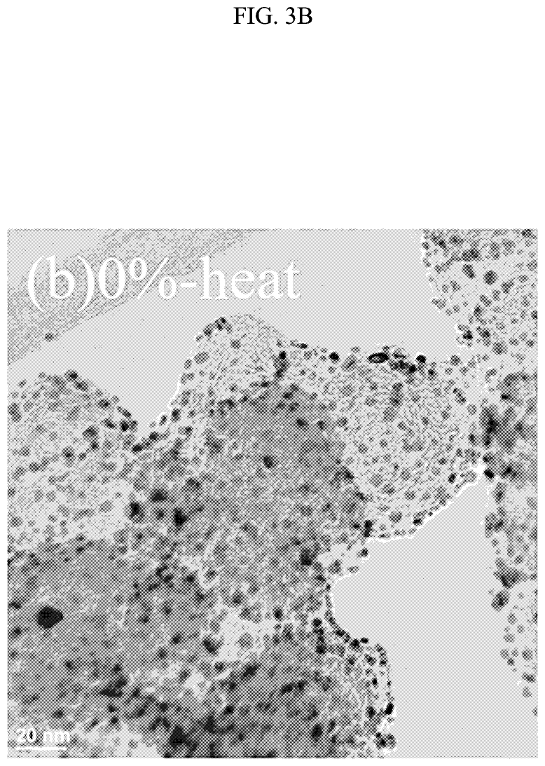

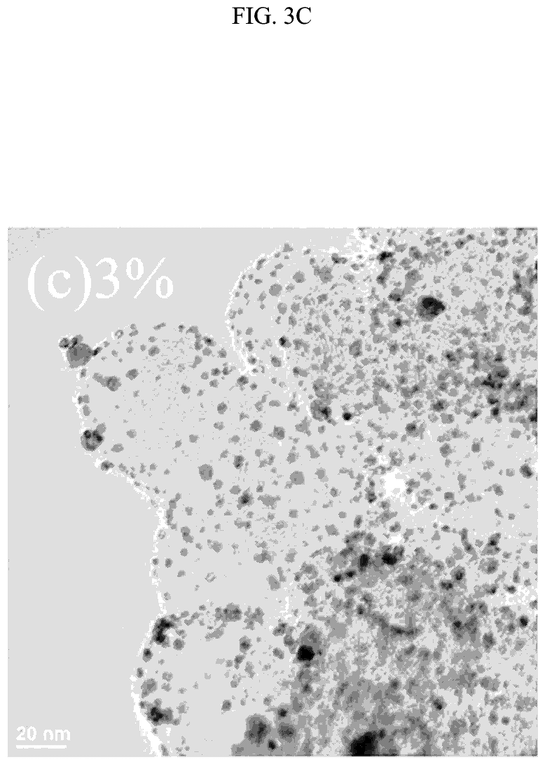

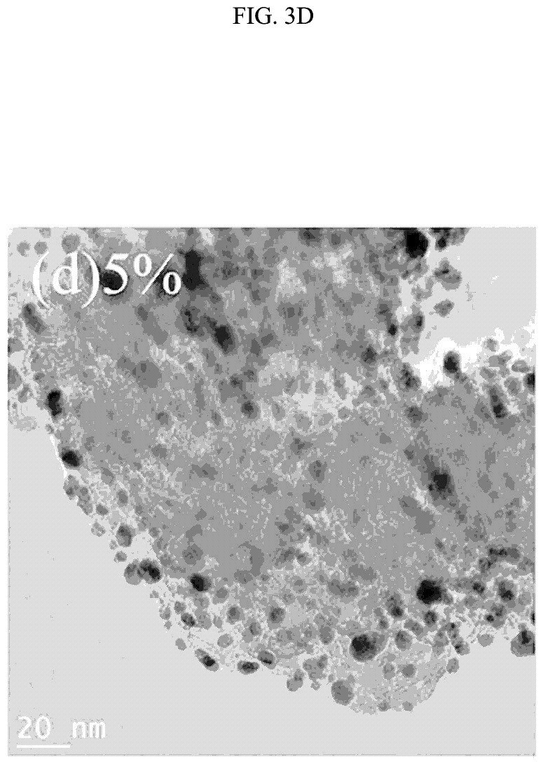

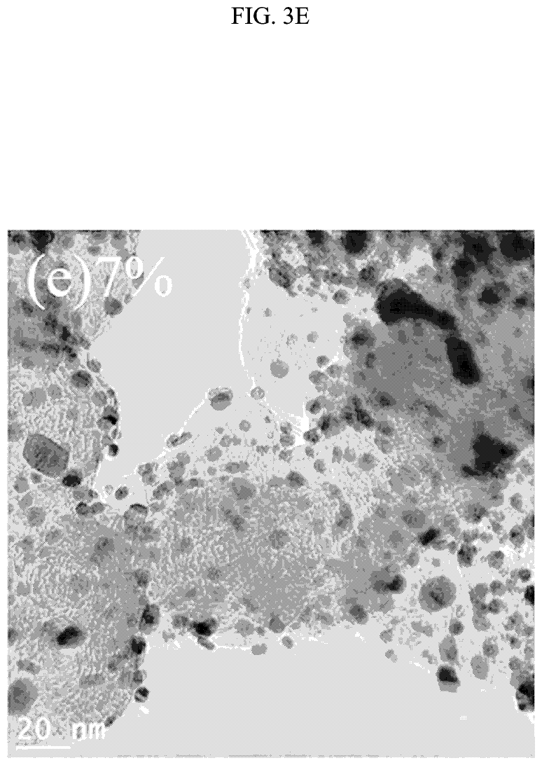

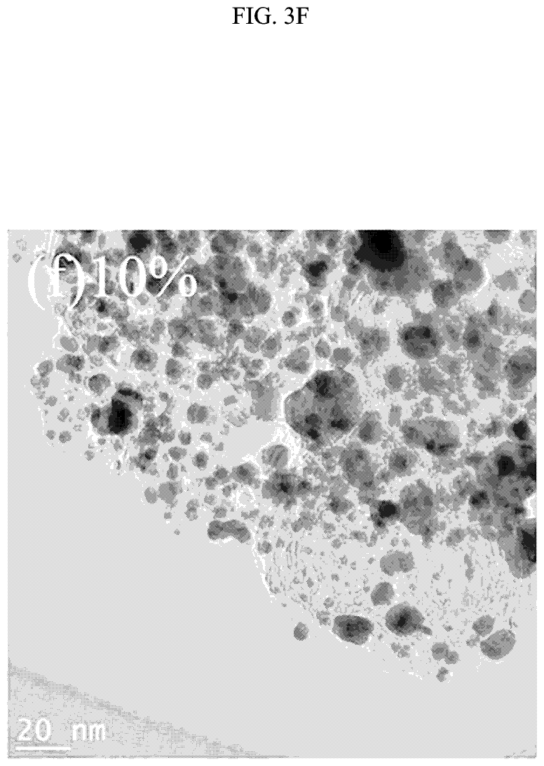

The analysis results are shown in FIGS. 3A to 3F: FIG. 3A shows the image of Pt/C; FIG. 3B shows the image of heat-treated Pt/C; FIG. 3C shows the image of heat-treated 3% Ti—Pt/C, FIG. 3D shows the image of heat-treated 5% Ti—Pt/C, FIG. 3E shows the image of an annealed 7% Ti—Pt/C, and FIG. 3F shows the image of an annealed 10% Ti—Pt/C catalyst.

The average particle sizes of the catalysts were about 2.8 nm, about 4.9 nm, about 5.2 nm, about 5.4 nm, about 6.3 nm, and about 7.2 nm in the order of (a) to (f), respectively, and it can be seen that the average particle size was increased as the amount of titanium loading was increased.

In particular, it was confirmed that in the case of the catalyst having a titanium loading amount of 7% or more, a large number of titanium particles with a size of 20 nm or more were distributed on the platinum surface. This shows that a part of titanium exists as titanium dioxide due to the pro-oxidation properties of titanium that is over-distributed.

### Experimental Example 2

### X-Ray Diffraction Pattern Analysis (XRD)

The crystal structures of the catalysts synthesized using a 50 nm electron beam according to the present disclosure were analyzed using an X-ray diffraction (XRD, Cu-Kα radiation) analyzer. X-ray diffraction analysis was performed to analyze the crystal structure of each particle at an angle of 10° to 90° through an accelerating voltage of 40 keV.

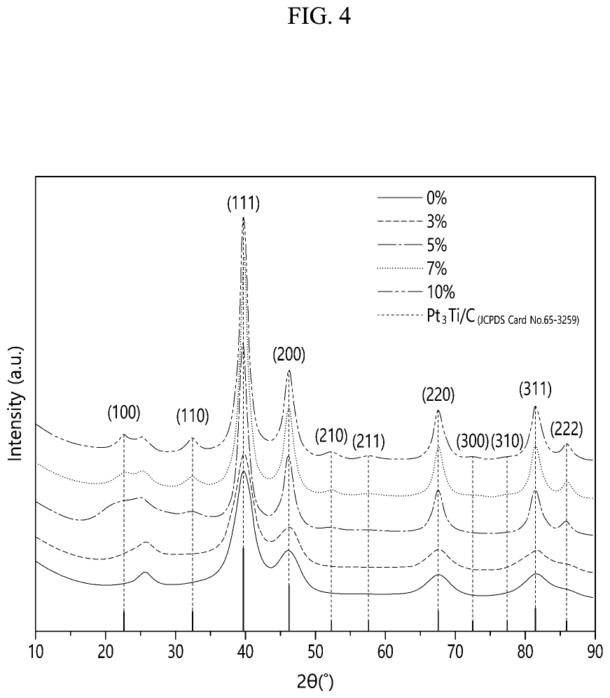

The analysis results are shown in FIG. 4, and are the analysis results for the heat-treated catalysts having titanium loadings of 0%, 3%, 5%, 7%, and 10%, respectively. Referring to FIG. 4, the Pt/C catalyst with a titanium loading of 0% had five main peaks at 39.7°, 46.2°, 67.5°, 81.5°, and 85.7°, and respective peaks had (111), (200), (220), (311), and (222) crystal planes. The lattice constant a of the synthesized Pt/C catalyst was 0.392 nm, indicating a face centered cubic structure (FCC).

The catalyst with a titanium loading of 3% or less showed a face-centered cubic structure similar to that of Pt/C, and the lattice constant a was slightly decreased to 0.3913 nm. This shows that alloying between titanium and platinum had occurred through heat treatment.

As the titanium loading amount was increased from 5% to 10%, new peaks appeared 22.8°, 32.4°, 52.5°, 57.8°, 72.6°, and 77.4°, which represent (100), (110), (210), (211), (300), and (310) of the Cu₃Au structure. In particular, it can be seen that the peaks are similar to those of the JCPDS card (65-3259) of Pt₃Ti/C. The greater loading amount of titanium, the stronger peaks of (100) and (110), and the feature that the lattice constant a is decreased to 0.3899 nm, indicates that the Cu₃Au structure developed regularly.

### Experimental Example 3

### Performance Evaluation of Fuel Cell Catalyst

### Catalyst Performance Evaluation Before Heat Treatment

Regarding the catalyst synthesized according to the present disclosure, the performance thereof before heat treatment with a titanium loading of 0% to 10% based on the catalyst (Pt/C catalyst or x wt % Ti doped Pt/C (x=3, 5, 7, 10)), was evaluated.

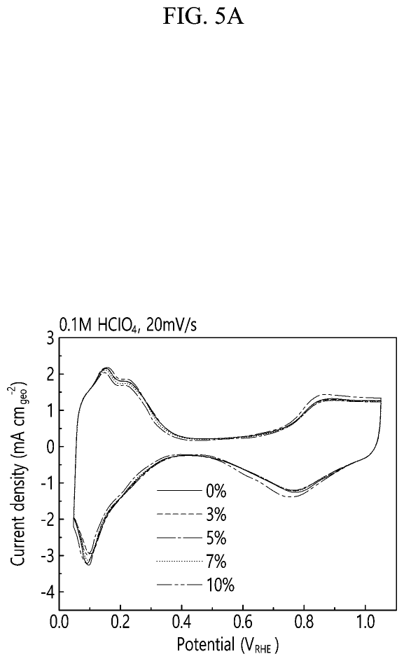

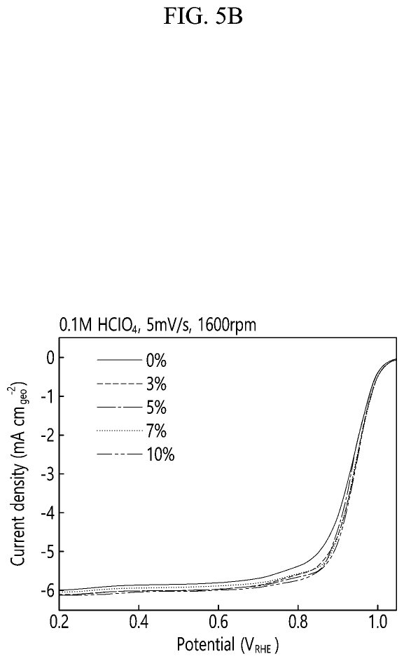

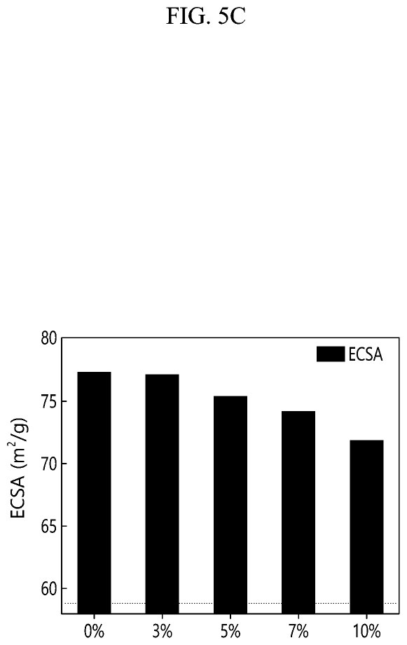

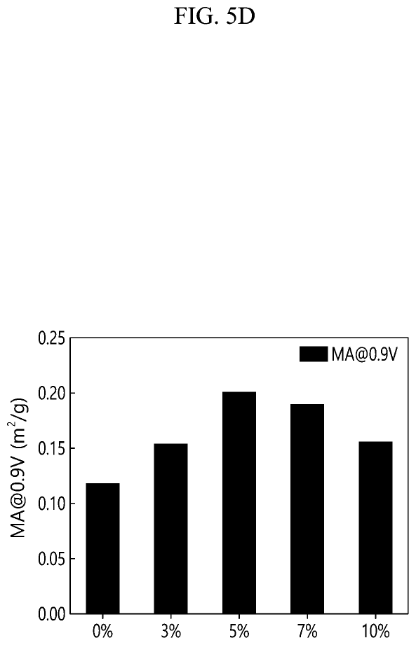

Results are shown in FIGS. 5A to 5D, where FIG. 5A shows performance comparison data of cyclic voltammetry, FIG. 5B shows performance comparison data of ORR polarization curve, FIG. 5C shows performance comparison data of electrochemical active surface area (ECSA), and FIG. 5D shows performance comparison data of mass activity @ 0.9 V.

The composition of the catalyst solution for catalyst performance evaluation was prepared as follows: 5 mg of Pt/C catalyst was prepared, and then dispersed, using an ultrasonic disperser, together with 500 μL of isopropyl alcohol in 50 μL of anhydrous ethanol containing 20 μL of distilled water and 2.5 μL naphthion solution (5 wt %) for 20 minutes. The synthesized catalyst was supported on a glassy carbon-rotating disk electrode (GC-RDE) on a working electrode. The loading amount of platinum was set to be 110 μg/cm².

All catalysts were activated by cyclic voltammetry at a scan rate of 100 mV/s in a potential window of 0.05 V to 1.05 V in a half-cell electrochemical reactor in a three-electrode system using 0.1 M perchloric acid (HClO₄) aqueous solution as an electrolyte. Cyclic voltammetry was performed at a scan rate of 20 mV/s in a potential window of 0.01 V to 1.05 V, and ECSA was evaluated.

In the case of the linear injection method, it was performed at a scan rate of 5 mV/s and at the electrode rotation speed of 1600 RPM, and the mass activity was compared and evaluated.

Referring to FIGS. 5A and 5C, it can be seen that the ECSA of the Pt/C catalyst showed 77.3 m²/g_{Pt} activity, 77.1 m²/g_{Pt} at the titanium loading of 3%, 75.4 m²/g_{Pt} at the titanium loading of 5%, and 74.2 m²/g_{Pt} at the titanium loading of 7%, 71.9 m²/g_{Pt} at the titanium loading of 10%, indicating that the ECSA performance gradually decreases with increasing titanium loading.

Referring to FIGS. 5B and 5D, it can be seen that by irradiation with an electron beam, even when titanium was simply supported on the platinum surface, the activity per mass at 0.9 V was enhanced from 0.118 A/mg_{Pt} (Pt/C) to 0.201 A/mg_{Pt} (5% Ti—Pt/C) for the oxygen reduction reaction.

At the titanium loading of 3%, the activity per mass was 0.154 A/mgPt; at 7%, the activity per mass was 0.19 A/mgPt; and at 10%, the activity per mass was 0.156 A/mgPt. In other words, at titanium loading of 5% to 7%, the oxygen reduction reaction was maintained, but at 10%, the activity was reduced.

In particular, when the supported titanium is over-distributed on the platinum surface, the oxygen reduction reaction on the platinum surface seems to be inhibited, resulting in loss of electrochemical performance.

### Catalyst Performance Evaluation After Heat Treatment

Regarding the catalyst synthesized according to the present disclosure, the performance thereof after heat treatment with a titanium loading of 0 to 10% based on the catalyst (Pt/C catalyst or x wt % Ti doped Pt/C (x=3, 5, 7, 10)) was evaluated.

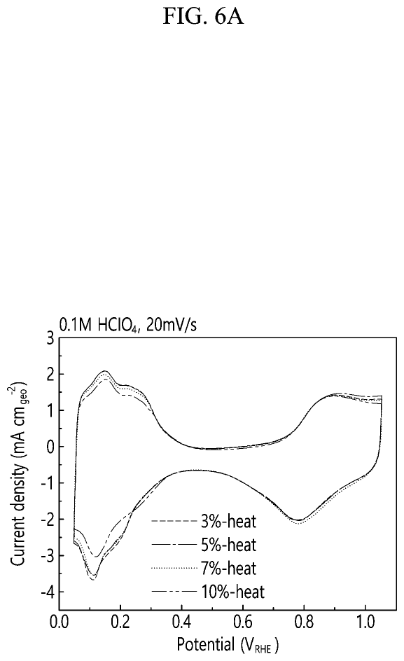

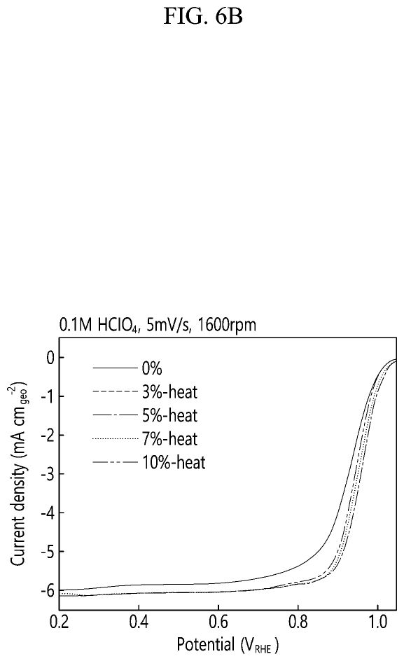

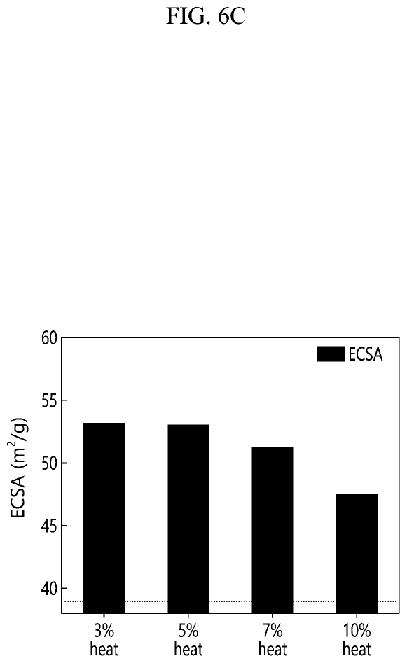

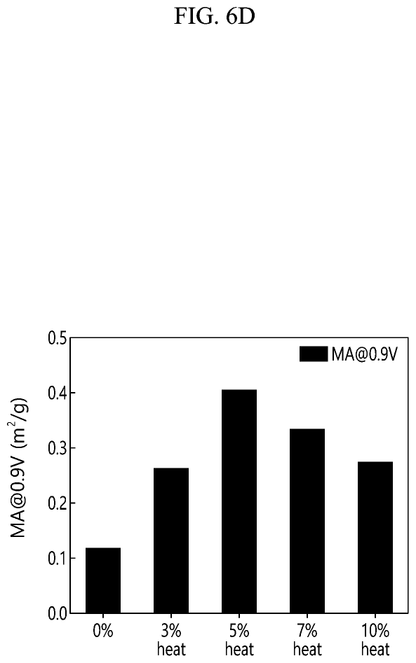

Results are shown in FIGS. 6A to 6D, where FIG. 6A shows performance comparison data of cyclic voltammetry, FIG. 6B shows performance comparison data of ORR polarization curve, FIG. 6C shows performance comparison data of electrochemical active surface area (ECSA), and FIG. 6D shows performance comparison data of mass activity @ 0.9 V.

The experimental method was as described above.

Referring to FIGS. 6A and 6C, the ECSA performance was decreased overall after heat treatment. This may be due to the increase in the catalyst particle size, as shown in FIGS. 3A to 3F.

The ECSA performance after heat treatment was 53.2 m²/g_{Pt} at a titanium loading of 3%, 53.1 m²/g_{Pt} at 5%, 51.3 m²/g_{Pt} at 7%, and 47.5 m²/g_{Pt} at 10%, indicating that similar to the pre-heat treatment catalysts described above, the catalysts with a titanium loading of 10% had suppressed oxygen reduction reactions due to the overdistribution of titanium.

Referring to FIGS. 6B and 6D, a regular Cu₃Au structure was induced through heat treatment at 850° C. for the titanium-supported Pt/C catalyst. In particular, the activity per mass on the 5% titanium-loaded catalyst was 0.407 A/mg_{Pt} (5% Ti—Pt/C-heat), showing a significant improvement in the oxygen reduction reaction compared to the catalyst without titanium (Pt/C, 0.118 A/mg_{Pt}) and the 5% titanium-loaded catalyst before heat treatment (5% Ti—Pt/C, 0.201 A/mg_{Pt}).

At a titanium loading of 3%, the activity per mass was 0.264 A/mg_{Pt}; at 7%, the activity per mass was 0.335 A/mg_{Pt}; and at 10%, and the activity per mass was 0.274 A/mg_{Pt}. This shows an increase in activity up to a titanium loading of 7% and a decrease in activity at a titanium loading of 10%.

### Performance Evaluation of Fuel Cell Catalysts

The performance of the Pt/C catalyst and the 5% Ti—Pt/C-heat catalyst synthesized according to the present disclosure before (BOL) and after (EOL) evaluation of catalyst deterioration, was evaluated.

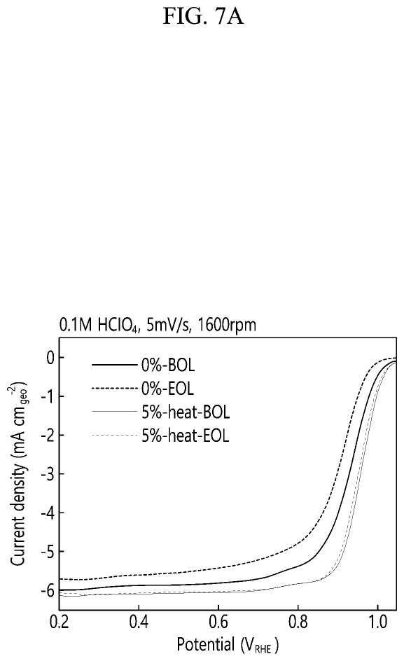

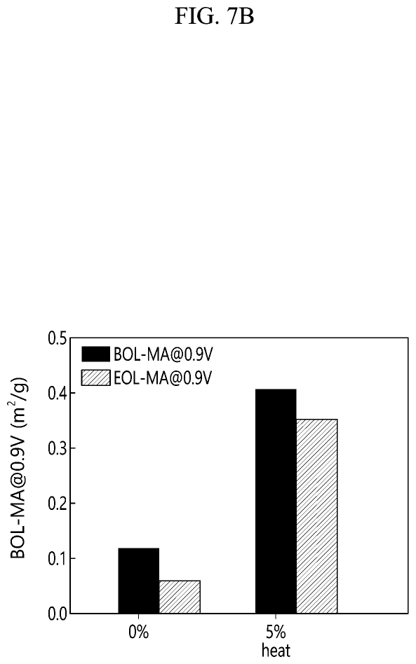

Results thereof are shown in FIGS. 7A and 7B. FIG. 7A shows an oxygen reduction reaction (ORR) polarization curve, and FIG. 7B shows mass activity @ 0.9V performance comparison data.

Referring to FIGS. 7A and 7B, the activity per mass of the Pt/C catalyst was decreased by 50.8% compared to the initial performance, and the activity per mass of the 5% Ti—Pt/C-heat catalyst was decreased by 13.5%.

Based on these results, it can be seen that when titanium is supported using an electron beam and heat treated, according to the present disclosure, the titanium is highly dispersed on the catalyst carrier, and thus, a highly active catalyst with a uniform particle size is formed, and high performance can be maintained.

As such, the present disclosure has been described with reference to an embodiment shown in the drawings, but this is merely an example, and those skilled in the art will understand that various modifications and variations of the embodiment can be made therefrom. Therefore, the true technical protection scope of the present disclosure should be determined by the technical spirit of the appended claims.

1. A method of producing a catalyst for a fuel cell, the method comprising:
forming a carbon support dispersion solution;
forming a first metal precursor-mixed solution by mixing a solution of a first metal precursor with the carbon support dispersion solution;
supporting a first metal by irradiating the first metal precursor-mixed solution with an electron beam;
injecting a second metal precursor into a first metal-supported mixed solution;
supporting a second metal by irradiating a second metal precursor-injected mixed solution with an electron beam; and
heat-treating a carbon support on which the second metal is supported.

2. The method of claim 1, wherein the carbon support comprises at least one selected from reduced graphene oxide, graphene, graphite, single-walled carbon nanotubes, multi-walled carbon nanotubes, carbon nanohorns, carbon nanofibers, acetylene black, and furnace black.

3. The method of claim 1, wherein the first metal precursor comprises a platinum (Pt) precursor.

4. The method of claim 1, wherein the first metal precursor comprises at least one selected from platinum acetylacetonate, platinum acetate, platinum chloride, and platinum nitrate.

5. The method of claim 1, wherein in the forming of the first metal precursor-mixed solution, a pH of the first metal precursor-mixed solution is adjusted to be basic.

6. The method of claim 1, wherein in the supporting of the first metal, the electron beam is irradiated for 20 minutes or less.

7. The method of claim 1, wherein the second metal precursor comprises at least one precursor of transition metal selected from Ti, Sc, V, Y, Zr, Nb, La, Hf, and Ta.

8. The method of claim 1, wherein the second metal precursor comprises at least one selected from TiCl₄, C₁₂H₂₈O₄Ti, Ti(OC₂H₅)₄, Ti(OBu)₄, C₁₂H₂₈O₄Ti, and [(CH₃)₂CHO]₂Ti(C₅H₇O₂)₂.

9. The method of claim 1, wherein the second metal precursor is injected by an in-situ method.

10. The method of claim 1, wherein in the injecting of the second metal precursor, a pH of the mixed solution is adjusted to be basic.

11. The method of claim 1, wherein in the supporting of the second metal, the electron beam is irradiated for 30 minutes or less.

12. The method of claim 1, wherein the supporting of the second metal comprises filtering and then drying the mixed solution to which the electron beam has been irradiated.

13. The method of claim 1, wherein in the heat treating, a heat treatment temperature is 800° C. to 950° C.

14. The method of claim 1, wherein in the heat treating, a heat treatment time is 1 hour to 5 hours.

15. A catalyst for a fuel cell, prepared by the method of claim 1.

16. A fuel cell comprising the catalyst of claim 15.
